(19) United States
(12) Patent Application Publication
(10) Pub. No.: US 2006/0025276 A1
(43) Pub. Date: Feb. 2, 2006

(54) Six-speed powertrain of an automatic transmission for a vehicle

(76) Inventor: Hyu Tae Shim, Hwaseong-city (KR)

Correspondence Address: MORGAN, LEWIS & BOCKIUS LLP (SF), 2 PALO ALTO SQUARE, 3000 El Camino Real, Suite 700, PALO ALTO, CA, 94306, US

(21) Appl. No.: 11/168,961

(22) Filed: Jun. 28, 2005

(30) Foreign Application Priority Data
Feb. 26, 2004 (KR) 10-2004-0013080

(51) Int. Cl. F16H 3/44

(52) U.S. Cl. 475/284

(57) ABSTRACT

The present invention provides a six-speed powertrain that includes: a first planetary gearset having operational elements of a first sun gear, a first planet carrier, and a first ring gear; a second planetary gearset having operational elements of a second sun gear, a third sun gear, a second planet carrier, a third planet carrier, and a third ring gear; an input shaft; an output gear; and a transmission case. A first clutch and a second clutch share a common clutch retainer. The first clutch variably connects the third sun gear to the first planet carrier The second clutch variably connects the second sun gear to the first planet carrier.

### FIELD OF THE INVENTION

The present invention relates to a six-speed powertrain of an automatic transmission for a vehicle.

### BACKGROUND OF THE INVENTION

A typical shift mechanism of an automatic transmission utilizes a combination of a plurality of planetary gearsets. A powertrain of such an automatic transmission, which includes a plurality of planetary gearsets, changes rotation speed and torque received from a torque converter of the automatic transmission, and accordingly changes and transmits the changed torque to an output shaft.

When a transmission realizes a greater number of shift speeds, speed ratios of the transmission can be more optimally designed. Therefore, a vehicle can have better fuel mileage and better performance. For this reason, automobile manufacturers constantly investigate ways to develop an automatic transmission that enables more shift speeds.

With the same number of speeds, the features of a powertrain, such as durability, efficiency in power transmission, and size, depend a lot on the layout of the combined planetary gearsets. Therefore, designs for a combined structure of a powertrain are also constantly under investigation.

Furthermore, a manual transmission that has too many speeds is inconvenient to use as it requires a driver to shift frequently. Therefore, the positive features of having more shift-speeds are more relevant and appropriate for automatic transmissions since automatic transmissions automatically control shifting operations without needing manual operation.

In addition to various developments regarding four and five speed powertrains, powertrains of automatic transmissions realizing six forward speeds and one reverse speed have recently been introduced.

The information disclosed in this section is only for enhancement of understanding of the background of the invention, and therefore, unless explicitly described to the contrary, it should not be taken as an acknowledgement or any form of suggestion that this information forms the prior art that is already known in this country to a person of ordinary skill in the art.

### SUMMARY OF THE INVENTION

The present invention provides a six-speed powertrain for an automatic transmission having the advantages of decreasing an overall length of a transmission by sharing a common clutch retainer and/or a brake retainer.

According to an embodiment of the present invention an exemplary six-speed powertrain for an automatic transmission includes a first planetary gearset, a second planetary gearset, an input shaft, an output gear, and a transmission case. The first planetary gearset has operational elements of a first sun gear, a first planet carrier, and a first ring gear. The second planetary gearset has operational elements of a second sun gear, a third sun gear, a second planet carrier, a third planet carrier, and a third ring gear. The first ring gear is fixedly connected to the input shaft, and the first sun gear is fixedly connected to the transmission case. The third sun gear is variably connected to the first planet carrier via a first clutch. The second planet carrier is variably connected to the transmission case via a first brake and a one-way clutch that are disposed in parallel. The second sun gear is variably connected to the transmission case via a second brake and is variably connected to the first planet carrier via a second clutch. The third planet carrier is variably connected to the first ring gear via a third clutch, and the third ring gear is fixedly connected to the output gear. The first clutch and the second clutch share a common clutch retainer.

The first, second, and third clutches may be disposed in a same direction of the input shaft with respect to the second planetary gearset.

The first and second brakes may share a common brake retainer.

The first and second clutches may be supplied With hydraulic pressure through a reaction shaft, and the third clutch is supplied with hydraulic pressure through the input shaft.

### BRIEF DESCRIPTION OF THE DRAWINGS

FIG. 1 is a schematic diagram of a six-speed powertrain according to an embodiment of the present invention;

FIG. 2 is a partially cut-away view of a six-speed powertrain according to an embodiment of the present invention;

FIG. 3 is a partially cut-away view of a six-speed powertrain according to another embodiment of the present invention;

FIG. 4 is an operational chart of a six-speed powertrain according to an embodiment of the present invention;

FIG. 5 illustrates speed diagrams for first, second, and third forward speeds of a six-speed powertrain according to an embodiment of the present invention; and

FIG. 6 illustrates speed diagrams for fourth, fifth, and sixth forward speeds, and a reverse speed of a six-speed powertrain according to an embodiment of the present invention.

### DETAILED DESCRIPTION OF THE PREFERRED EMBODIMENTS

Embodiments of the present invention will hereinafter be described in detail with reference to the accompanying drawings.

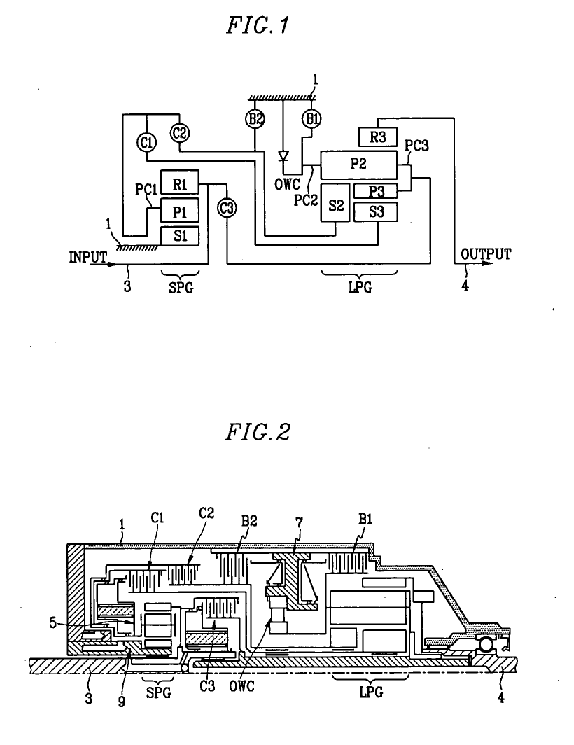

FIG. 1 is a schematic diagram of a six-speed powertrain according to an embodiment of the present invention. This six-speed powertrain includes a first planetary gearset SPG, a second planetary gearset LPG, an input shaft 3, an output gear 4, and a transmission case 1.

An input shaft 3 is connected to an engine output shaft (not shown) via a torque converter (not shown), and the first planetary gearset SPG and the second planetary gearset LPG are disposed within the transmission case 1. The first planetary gearset SPG is disposed in a front portion of the input shaft 3, i.e., in a left portion of FIG. 1, and the second planetary gearset LPG is disposed in a rear portion of the first planetary gearset SPG.

The first planetary gearset SPG is a single pinion planetary gearset, and includes a first sun gear S1, a first ring gear R1, and a first carrier PC1 as operational elements. A first pinion gear P1, which engages with the first ring gear R1 and the first sun gear S1, is rotatably connected to, and carried by, the first planet carrier PC1.

The second planetary gearset LPG is a Ravingneaux planetary gearset, and includes a second sun gear S2, a third sun gear S3, a third ring gear R3, a second planet carrier PC2, and a third planet carrier PC3 as operational elements. A second planetary gear P2, which engages with the second sun gear S2 and the third ring gear R3, is rotatably connected to and carried by the second planet carrier PC2. A third planetary gear P3, which engages respectively with the second planetary gear P2 and the third sun gear S3, and second planetary gear P2 are rotatably connected to, and carried by, the third planet carrier PC3.

The first planetary gearset SPG is disposed in a front portion of the transmission, i.e., in a left portion of FIGS. 1 to 3, and the second planetary gearset LPG is disposed in a rear portion of the transmission, ie., in a right portion of FIGS. 1 to 3.

Hereinafter, the third sun gear S3, the third ring gear R3, the second and third planet carriers PC2 and PC3, the second sun gear S2, the first ring gear R1, the first planet carrier PC1, and the first sun gear S1 are referred to respectively as a first operational element, a second operational element, a third operational element, a fourth operational element, a fifth operational element, a sixth operational element, and a seventh operational element.

The first operational element is selectively connected to the sixth operational element. The second operational element always acts as an output element. The third operational element operates as an input element or a fixed element. The fourth operational element acts as a fixed element or is selectively connected to the sixth operational element. The fifth operational element acts always as an input element. Finally, the seventh operational element acts as a fixed element.

The first ring gear R1 is fixedly connected to the input shaft 3, and the first sun gear S1 is fixedly connected to the transmission case 1. The third sun gear S3 is variably connected to the first planet carrier PC1 via the first clutch C1. The third ring gear R3 is fixedly connected to the output gear 4 and thereby acts as an output element. The second planet carrier PC2 is variably connected to the transmission case 1 via the first brake B1 and the one-way clutch OWC, which are disposed in parallel. The third planet carrier PC3 is variably connected to the first ring gear R1 via the third clutch C3.

The second sun gear S2 is variably connected to the transmission case 1 via the second brake B2, and is variably connected to the first planet carrier PC1 via the second clutch C2. The first ring gear R1 is fixedly connected to the input shaft 3 and thereby acts always as an input element. The first sun gear S1 is fixedly connected to the transmission case 1 and thereby always acts as a fixed element.

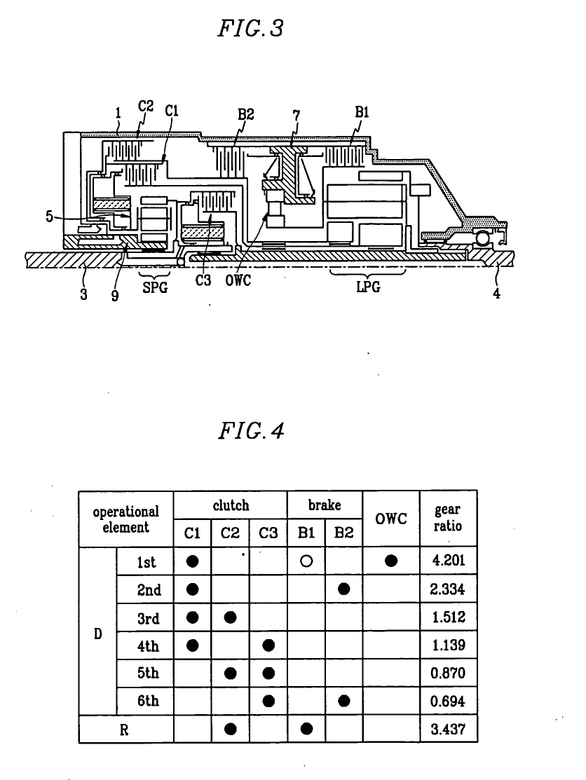

As shown in FIGS. 2 and 3, the first and second clutches C1 and C2 are disposed to be adjacent to each other and share a common clutch retainer 5. Since the first and second clutches C1 and C2 share the common clutch retainer 5, an overall length of the transmission can be decreased substantially.

The first, second, and third clutches C1, C2, and C3, as shown in FIG. 2 or FIG. 3, are disposed in the same direction as the input shaft 3 with respect to the second planetary gearset LPG. That is, referring to FIGS. 2 and 3, the first, second, and third clutches C1, C2, and C3 are disposed in a front portion of the transmission, i.e., in a left portion of FIGS. 2 and 3.

The first and second brakes B1 and B2 are disposed, with the one-way clutch OWC, between the first planetary gearset SPG and the second planetary gearset LPG. The first and second brakes B1 and B2 are disposed adjacently to each other within the transmission case 1 and share a common brake retainer 7.

The first and second clutches C1 and C2 are supplied with hydraulic pressure through a reaction shaft 9 that is fixed to a hydraulic pump (not shown) in the transmission. The third clutch C3 is supplied with hydraulic pressure though the input shaft 11.

FIG. 2 and FIG. 3 are partially cut-away views of powertrains according to different embodiments of the present invention. Referring to FIG. 2, according to an embodiment of the present invention, the first clutch C1 and the second clutch C2 share a common clutch retainer 5. The first and second clutches C1 and C2 are sequentially disposed along a longitudinal direction of the transmission. In particular, the first clutch C1 is disposed in a front portion of the transmission, and the second clutch C2 is disposed at a rear portion of the first clutch C1. Referring to FIG. 3, according to another embodiment of the present invention, the first clutch C1 and the second clutch C2 also share the common clutch retainer 5. The first and second clutches C1 and C2 are sequentially disposed in a radial direction. In particular, the first clutch Cl is disposed inside of the second clutch C2.

Since, according to embodiments of the present invention, two clutches and two brakes have common retainers, an overall length of the transmission can be decreased substantially.

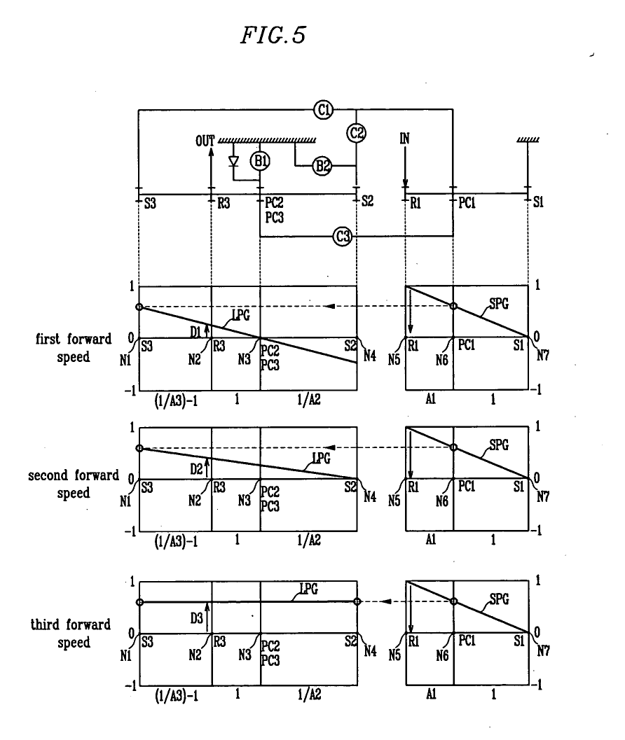

As shown in the operational chart in FIG. 4, the first clutch C1 and the one-way clutch OWC are operated at the first forward speed, and the first clutch C1 and the second brake B2 are operated at the second forward speed. The first clutch C1 and the second clutch C2 are operated at the third forward speed, and the first clutch C1 and the third clutch C3 are operated at the fourth forward speed. The second and third clutches C2 and C3 are operated at the fifth forward speed, and the third clutch C3 and the second brake B2 are operated at the sixth forward speed. The second clutch C2 and the first brake B1 are operated at the reverse speed. Therefore, six forward speeds and one reverse speed can be realized.

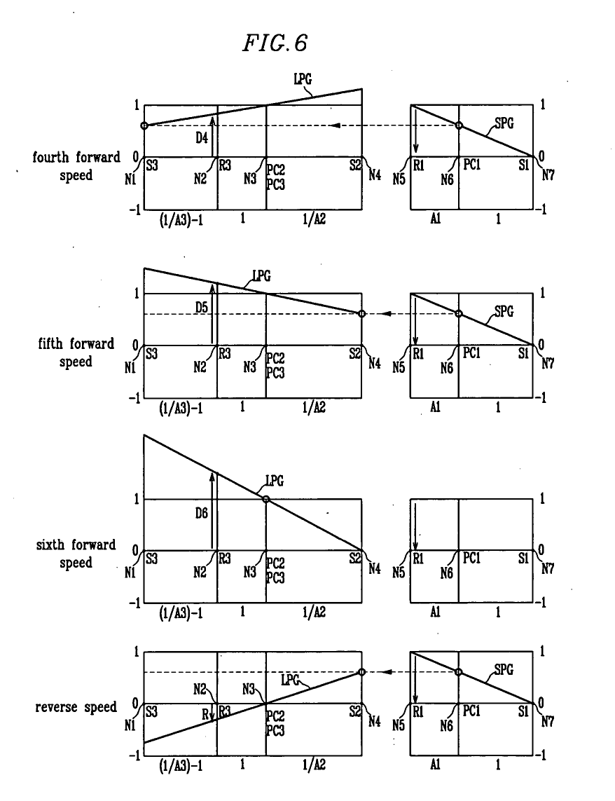

Accordingly, seven operational nodes N1 to N7 are disposed on a speed diagram as shown in FIGS. 5 and 6. A first node N1 indicating the first operational element corresponds to the third sun gear S3. A second node N2 indicating the second operational element corresponds to the third ring gear R3. A third node N3 indicating the third operational element corresponds to the second and third planet carriers PC2 and PC3. A fourth node N4 indicating the fourth operational element corresponds to the second sun gear S2. A fifth node N5 indicating the fifth operational element corresponds to the first ring gear R1. A sixth node N6 indicating the sixth operational element corresponds to the first planet carrier PC1. Finally, a seventh node N7 indicating the seventh operational element corresponds to the first sun gear S1.

FIGS. 5 and 6 illustrate speed diagrams for the six forward speeds and one reverse speed of the powertrain according to an embodiment of the present invention. As stated above, the seventh node N7 corresponding to the first sun gear S1 always acts as a fixed element.

The first clutch C1 and the one-way clutch OWC are operated at the first forward speed. Accordingly, if an input speed is applied to the fifth node N5 corresponding to the first ring gear R1 of the first planetary gearset SPG, a reduced input speed at the sixth node N6 corresponding to the first planet carrier PC1 is transmitted to the first node N1 corresponding to the third sun gear S3 of the second planetary gearset LPG due to the operation of the first clutch C1. In addition, the third node N3 corresponding to the second and third planet carriers PC2 and PC3 is stationary since the one-way clutch OWC operates. Therefore, due to the operation of the second planetary gearset LPG, speed lines of the first forward speed are formed as shown in FIG. 5, and an output speed D1 at the second node N2 acting as an output element is obtained, thereby realizing the first forward speed.

The first clutch C1 and the second brake B2 are operated at the second forward speed. Accordingly, if an input speed is applied to the fifth node N5 corresponding to the first ring gear R1 of the first planetary gearset SPG, a reduced input speed at the sixth node N6 corresponding to the first planet carrier PC1 is transmitted to the first node N1 corresponding to the third sun gear S3 of the second planetary gearset LPG due to the operation of the first clutch C1. In addition, the fourth node N4 corresponding to the second sun gear S2 is stationary due to the operation of the second brake B2. Therefore, due to the operation of the second planetary gearset LPG, speed lines of the second forward speed are formed as shown in FIG. 5, and an output speed D2 at the second node N2 acting as an output element is obtained, thereby realizing the second forward speed.

The first clutch C1 and the second clutch C2 are operated at the third forward speed. Accordingly, if an input speed is applied to the fifth node N5 corresponding to the first ring gear R1 of the first planetary gearset SPG, a reduced input speed at the sixth node N6 corresponding to the first planet carrier PC1 is transmitted to the first node N1 corresponding to the third sun gear S3 of the second planetary gearset LPG due to the operation of the first clutch C1. In addition, the reduced input speed at the sixth node N6 is also transmitted to the fourth node N4 corresponding to the second sun gear S2 due to the operation of the second clutch C2. Therefore, due to the operation of the second planetary gearset LPG, speed lines of the third forward speed are formed as shown in FIG. 5, and an output speed D3 at the second node N2 acting as an output element is obtained, thereby realizing the third forward speed.

The first clutch C1 and the third clutch C3 are operated at the fourth forward speed. Accordingly, if an input speed is applied to the fifth node N5 corresponding to the first ring gear R1 of the first planetary gearset SPG, a reduced input speed at the sixth node N6 corresponding to the first planet carrier PC1 is transmitted to the first node N1 corresponding to the third sun gear S3 of the second planetary gearset LPG due to the operation of the first clutch C1. In addition, an input speed is transmitted to the node N3 corresponding to the second and third planet carriers PC2 and PC3 due to the operation of the third clutch C3. Therefore, due to the operation of the second planetary. gearset LPG, speed lines of the fourth forward speed are formed as shown in FIG. 6, and an output speed D4 at the second node N2 acting as an output element is obtained, thereby realizing the fourth forward speed.

The second clutch C2 and the third clutch C3 are operated at the fifth forward speed. Accordingly, if an input speed is applied to the fifth node N5 corresponding to the first ring gear R1 of the first planetary gearset SPG, a reduced input speed at the sixth node N6 corresponding to the first planet carrier PC1 is transmitted to the fourth node N4 corresponding to the second sun gear S2 of the second planetary gearset LPG due to the operation of the second clutch C2. In addition, an input speed is transmitted to the node N3 corresponding to the second and third planet carriers PC2 and PC3 due to the operation of the third clutch C3. Therefore, due to the operation of the second planetary gearset LPG, speed lines of the fifth forward speed are formed as shown in FIG. 6, and an output speed D5 at the second node N2 acting as an output element is obtained, thereby realizing the fifth forward speed.

The third clutch C3 and the second brake B2 are operated at the sixth forward speed. Accordingly, an input speed is directly transmitted to the node N3 corresponding to the second and third planet carriers PC1 and PC2 due to the operation of the third clutch C3 operates. In addition, the node N4 corresponding to the second sun gear S2 is stationary due to the operation of the second brake B2. Therefore, due to the operation of the second planetary gearset LPG, speed lines of the sixth forward speed are formed as shown in FIG. 6, and an output speed D6 at the second node N2 acting as an output element is obtained, thereby realizing the sixth forward speed.

The second clutch C2 and the first brake B1 are operated at the reverse speed. Accordingly, if an input speed is applied to the fifth node N5 corresponding to the first ring gear R1 of the first planetary gearset SPG, a reduced input speed at the sixth node N6 corresponding to the first planet carrier PC1 is transmitted to the fourth node N4 corresponding to the second sun gear S2 of the second planetary gearset LPG due to the operation of the second clutch C2. In addition, the third node N3 corresponding to the second and third planet carriers PC1 and PC2 is stationary due to the operation of the first brake B1. Therefore, due to the operation of the second planetary gearset LPG, speed lines of the reverse speed are formed as shown in FIG. 6, and an output speed R at the second node N2 acting as an output element is obtained, thereby realizing the reverse speed.

A person having ordinary skill in the art can easily obtain the above-stated speed lines at each speed based on the structural features and operational chart of the powertrain according to an embodiment of the present invention.

Gear ratios of the six-speed powertrain according to an embodiment of the present invention may be set at 4.201 for the first forward speed, at 2.334 for the second forward speed, at 1.512 for the third forward speed, at 1.139 for the fourth forward speed, at 0.870 for the fifth forward speed, at 0.694 for the sixth forward speed, and at 3.437 for the reverse speed.

While the present invention has been described in connection with the most practical exemplary embodiments, it is to be understood that the invention is not limited to the disclosed embodiments, but, on the contrary, is intended to cover various modifications and equivalent arrangements included within the spirit and scope of the appended claims

According to the six-speed powertrain according to embodiments of the present invention, the first clutch variably connecting the third sun gear to the first planet carrier and the second clutch variably connecting the second sun gear to the first planet carrier share a common clutch retainer, so that an overall length of the transmission can be substantially decreased and passages of hydraulic pressure can be easily formed. In addition, because the first, second, and third clutches are disposed in a same direction of the input shaft with respect to the second planetary gearset, an overall length of the transmission can be further decreased. Furthermore, because the first and second brakes share a common brake retainer, an overall length of the transmission can be further decreased. Moreover, since hydraulic pressure is supplied through the reaction shaft and the input shaft, lengths of hydraulic passages can be decreased and thereby hydraulic responsiveness can be improved.

What is claimed is:

1. A six-speed powertrain for an automatic transmission comprising:
a first planetary gearset having operational elements of a first sun gear, a first planet carrier, and a first ring gear;
a second planetary gearset having operational elements of a second sun gear, a third sun gear, a second planet carrier, a third planet carrier, and a third ring gear;
an input shaft;
an output gear; and
a transmission case,
wherein:
the first ring gear is fixedly connected to the input shaft;
the first sun gear is fixedly connected to the transmission case;
the third sun gear is variably connected to the first planet carrier via a first clutch;
the second planet carrier is variably connected to the transmission case via a first brake and a one-way clutch that are disposed in parallel;
the second sun gear is variably connected to the transmission case via a second brake and is variably connected to the first planet carrier via a second clutch;
the third planet carrier is variably connected to the first ring gear via a third clutch;
the third ring gear is fixedly connected to the output gear; and
the first clutch and the second clutch share a common clutch retainer.

2. The six-speed powertrain of claim 1, wherein the first, second, and third clutches are disposed in a same direction of the input shaft with respect to the second planetary gearset.

3. The six-speed powertrain of claim 1, wherein the first and second brakes share a common brake retainer.

4. The six-speed powertrain of claim 1, wherein the first and second clutches are supplied with hydraulic pressure through a reaction shaft, and the third clutch is supplied with hydraulic pressure through the input shaft.
